(19) United States
(12) Patent Application Publication
(10) Pub. No.: US 2014/0217752 A1
(43) Pub. Date: Aug. 7, 2014

(54) LATCH MECHANISM

(71) Applicants: Francisco Javier Lujan, Cuidad Juarez (MX); Fernando Chacon Ramos, Cuidad Juarez (MX); Donald Michael Perkins, Sterling Heights, MI (US); Kurt E. Nurmi, Macomb, MI (US)

(72) Inventors: Francisco Javier Lujan, Cuidad Juarez (MX); Fernando Chacon Ramos, Cuidad Juarez (MX); Donald Michael Perkins, Sterling Heights, MI (US); Kurt E. Nurmi, Macomb, MI (US)

(21) Appl. No.: 14/169,681

(22) Filed: Jan. 31, 2014

Related U.S. Application Data
(60) Provisional application No. 61/760,276, filed on Feb. 4, 2013.
(60) Provisional application No. 61/760,274, filed on Feb. 4, 2013.

(51) Int. Cl. E05B 77/38

(52) U.S. Cl. CPC E05B 77/38
USPC 292/216

(57) ABSTRACT

A latch is provided including a fork bolt configured to rotate between an unlatch position and a latched position. A detent is configured to cooperate with the forkbolt. A bumper includes an upper contact portion and an elongated lower portion. The bumper is configured to receive a striker when the fork bolt is in the latched position. A guide member includes a generally curved flexible portion. The flexible portion is configured to deflect about a first end to guide the striker towards the upper contact portion of the bumper.

### CROSS REFERENCE TO RELATED APPLICATIONS

This application claims the benefit of U.S. Provisional Patent Application Ser. No. 61/760,276 filed Feb. 4, 2013, the contents of which are incorporated herein by reference thereto. This application also claims the benefit of U.S. Provisional Patent Application Ser. No. 61/760,274 filed Feb. 4, 2013, the contents of which are also incorporated herein by reference thereto.

### TECHNICAL FIELD

Exemplary embodiments of the present invention relate generally to latches and, more particularly, to latches for vehicles.

### BACKGROUND

Latches are used to restrain the movement of one member or element with respect to another. For example, door latches restrain the movement of a door with respect to a surrounding door flame. The function of such latches is to hold the door secure within the frame until the latch is released and the door is free to open, Existing latches typically have mechanical connections linking the latch to actuation elements such as handles which can be actuated by a user to release the latch. Movement of the actuation elements is transferred through the mechanical connections that cause the latch to release. The mechanical connections can be one or more rods, cables, or other suitable elements or devices.

Latch sound quality can enhance or detract from the overall perception of quality by an end user about the construction of the vehicle. For example, good sound quality may imply solid construction, smooth operation, and thoughtfulness of design. As a result, vehicle manufacturers are placing more emphasis on the ability of the door latch to absorb the noise emissions that may occur during a closing event. Sound quality metrics, such as minimal loudness and frequency content for example, are affected by many variables including the profile geometry, small features, and material selection of the components of a latch mechanism.

Accordingly, while existing vehicle latch mechanisms are suitable, the need for improvement remains, particularly in providing a latch mechanism having improved noise dampening and energy absorption.

### SUMMARY OF THE INVENTION

In accordance with one embodiment, a latch is provided including a fork bolt configured to rotate between an unlatch position and a latched position. A detent is configured to cooperate with the forkbolt. A bumper includes an upper contact portion and an elongated lower portion. The bumper is configured to receive a striker when the fork bolt is in the latched position. A guide member includes a generally curved flexible portion. The flexible portion is configured to deflect about a first end to guide the striker towards the upper contact portion of the bumper.

The above-described and other features and advantages of the present invention will be appreciated and understood by those skilled in the art from the following detailed description, drawings, and appended claims.

### BRIEF DESCRIPTION OF THE DRAWINGS

Embodiments of the present invention will now be described, by way of example only, with reference to the accompanying drawings in which:

FIG. 1 is a is a front view of a latch mechanism in a primary latched position according to an embodiment of the invention;

FIG. 2 is a is a front view of a latch mechanism in a secondary latched position according to an embodiment of the invention;

FIG. 3 is a front view of a bumper of the latch mechanism according to an embodiment of the invention;

FIG. 4 is a perspective view of a guide member of a latch mechanism according to an embodiment of the invention; and

FIG. 5 is a front view of a latch mechanism in a secondary latched position according to an embodiment of the invention.

### DETAILED DESCRIPTION

With reference to all of the FIGS., an exemplary latch 10 having improved sound performance is illustrated. The latch 10 is movable between a latched position and an unlatched position, and is configured to have a housing 20. The latch 10 may be integrated into a component of a vehicle, such as the vehicle structure adjacent a lift gate, trunk, door, or any other operable component for example.

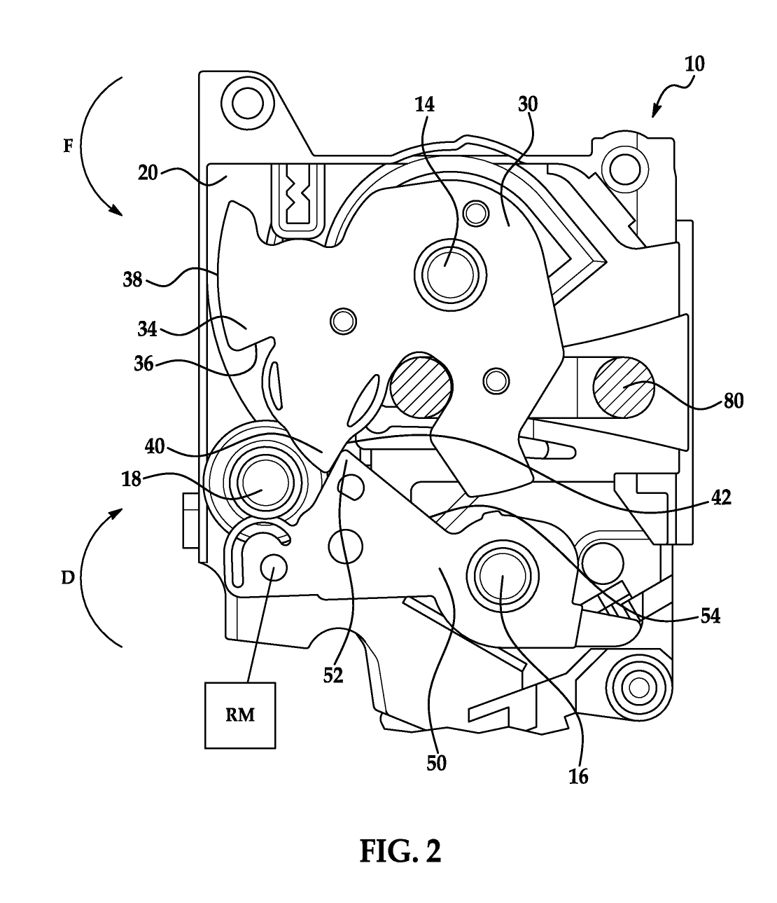

The latch 10 includes a fork bolt 30 and a cooperating detent lever 50 for maintaining the fork bolt 30 in the latched position. The fork bolt 30 and the detent lever 50 are each pivotally mounted to the housing 20 of the latch 10 by a stud (not shown) positioned in holes 14, 16 respectively. The fork bolt 30 is biased in the direction of arrow F by a first biasing mechanism (not shown), and the detent lever 50 is biased in the direction of arrow D, into engagement with the fork bolt 30, by a second biasing mechanism (not shown). In one embodiment, the first and second biasing mechanisms are coil or torsion springs. The fork bolt 30 has a slot or throat 32 for receiving and retaining a striker 80 (see FIG. 2), such as a wire-loop striker for example, located on a complementary vehicle component, such as a lift gate or trunk. The fork bolt 30 also includes a primary shoulder 40 and an intermediate or secondary shoulder 34. The secondary shoulder 34 of the fork bolt 30 includes a contact surface 38 configured to contact an engagement surface 54 of the detent lever 50 when rotating between an unlatched and a latched position

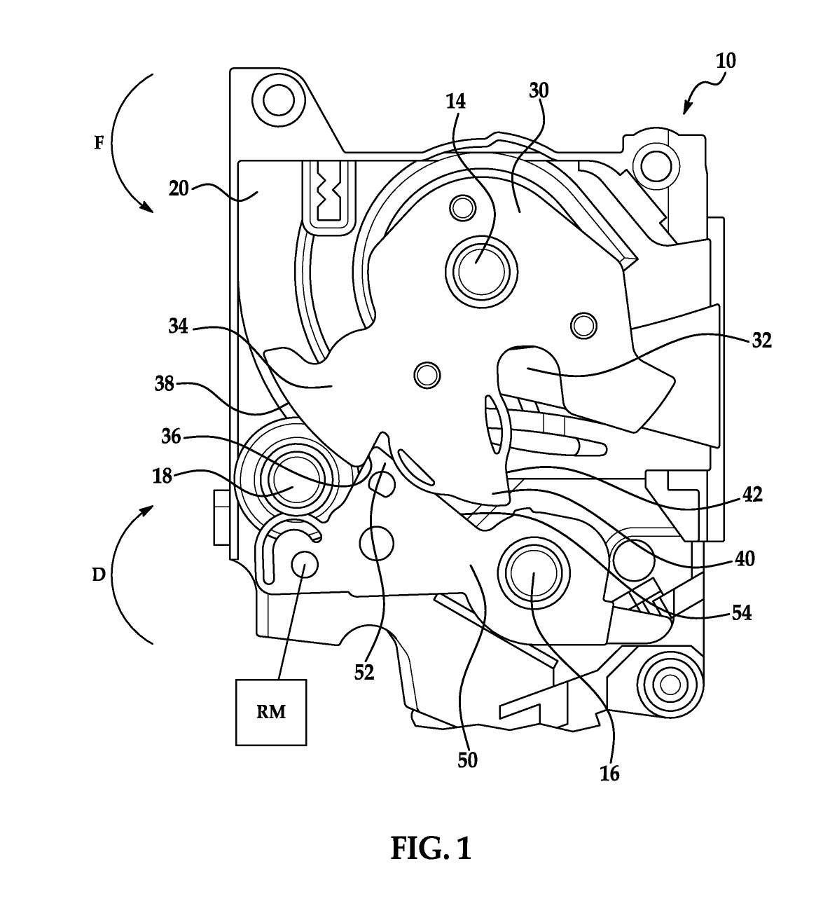

The detent lever 50 includes a sector-shaped catch 52 configured to positively engage a surface 42, 36 of each of the primary and secondary shoulders 40, 34 to hold the fork bolt 30 against the bias of the first biasing mechanism in either a primary latched position (FIG. 2) or secondary latched position (FIG. 1) respectively. In one embodiment, a portion of the detent lever 50 is coupled to a release mechanism RM, illustrated schematically in FIGS. 1 and 2. Activation of the release mechanism RM applies a rotational force to the detent lever 50 in a direction opposite the direction indicated by arrow D. The aforementioned fork bolt 30 and detent lever 50 are illustrated as a non-limiting embodiment. Numerous other types or configurations of the fork bolt 30 and detent lever 50 are considered to be within the scope of an exemplary embodiment of the present invention.

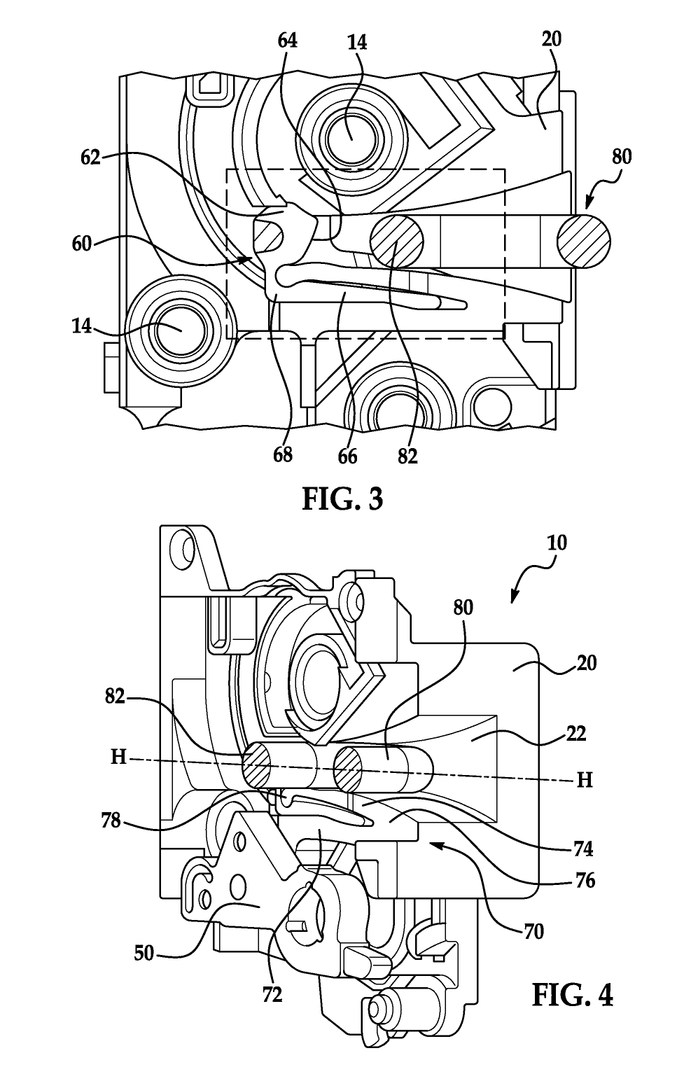

Referring now to FIG. 3, a bumper 60 is arranged between the housing 20 and the plane in which the fork bolt 30 and detent lever 50 rotate. The bumper 60 is positioned adjacent the interface between the sector-shaped catch 52 of the detent lever 50 and the shoulders 40, 34 of the fork bolt 30. The bumper 60 includes an upper contact portion 62 and an elongated lower portion 66 arranged substantially perpendicularly to the upper contact portion 62. In one embodiment, the bumper 60 is made from a flexible material, such as rubber or soft plastic for example. An engagement surface 64 of the upper contact portion 62 is angled towards the bend 68 between the upper and lower portions 62, 66 of the bumper 60. The bumper 60 is configured to dampen sound generated by the contact between the fork bolt 30 and the striker wire 80. Vibration and resultant noise of the striker wire 80 are thus absorbed from the portion 82 wedged between the upper contact portion 62 and the elongated lower portion 66.

As best illustrated in FIG. 4, a guide member 70 extends from near the opening 22 of the housing 20 for receiving and guiding the striker 80 to adjacent the bend 68 of the bumper 60. The guide member 70 includes a rigid base 72 and a generally curved flexible portion 74 connected at a first end 76. In one embodiment, at least a portion of the guide member 70, such as the rigid base 72 for example, is formed integrally with the housing 20. The flexible portion 74 is configured to rotate about the first end 76, towards the base 72, to guide the portion 82 of the striker wire 80 towards the bend 68 of the bumper 60, between the upper and lower portions 62, 66.

As the striker wire 80 enters the opening 22 of the housing 20 and the throat 32 of the fork bolt 30, the striker wire 80 applies a force to the primary shoulder 40, thereby causing the fork bolt 30 to pivot in a direction opposite the direction indicated by arrow F, and thus the fork bolt 30 moves from an unlatched position to a latched position. During this movement, the contact surface 38 of the secondary shoulder 34 slidably contacts the engagement surface 54 of the detent lever 50 such that the detent lever 50 is rotated in a direction opposite the direction indicated by arrow D, away from the fork bolt 30.

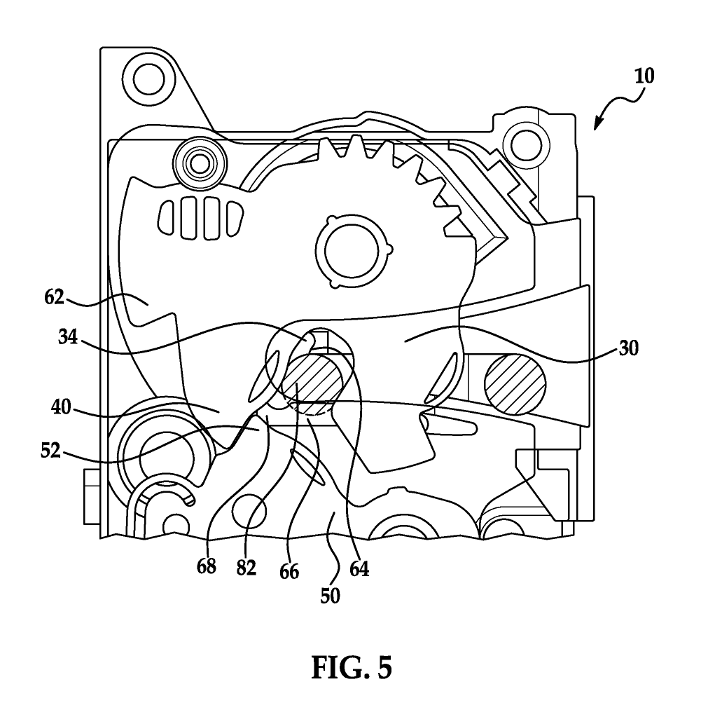

The striker wire 80 moves along a substantially horizontal plane H (see FIG. 4) as the fork bolt 30 rotates between an unlatched and a latched position. As the fork bolt 30 pivots from the primary latched position to the secondary latched position, portion 82 of the striker wire 80 slidably contacts the flexible portion 74 of the guide member 70 and applies a force thereto. As a result of the generally curved geometry of the flexible portion 74, the deflection of the flexible portion 74 towards the base 72 increases as portion 82 approaches the free end 78 of the guide member 70. The bending of the flexible portion 74 is complementary to the contour of the lower portion 66 of the bumper 60. In one embodiment, the deflection of the flexible portion 74 is designed so as to guide portion 82 of the striker wire 80 along the lower portion 66 toward the upper portion 62. When the striker 80 contacts the upper contact surface 64, portion 82 is adjacent the free end 78 of the flexible portion 74. Further rotation of the fork bolt 30 applies a force to the striker wire 80, which causes portion 82 to wedge between the angled upper surface 64 and the elongated lower portion 66 adjacent the bend 68, as illustrated in FIG. 5.

Once the fork bolt 30 reaches the primary latched position, the detent lever 50 is biased into contact with the primary shoulder 40 of the fork bolt 30, thereby preventing the fork bolt 30 from rotating towards the unlatched position until the detent lever 50 is mechanically released or disengaged. The bumper 60 prevents further rotation of the fork bolt 30 beyond the primary latched position. To open the latch 10, actuation of the release mechanism RM coupled to the detent lever 50 causes the detent lever 50 to rotate out of engagement with the fork bolt 30. The biasing mechanism acting on the fork bolt 30 causes the fork bolt 30 to pivot in the direction indicated by arrow F, towards the unlatched position. As the fork bolt 30 rotates open, the primary shoulder 40 applies a force to portion 82 of the striker wire 80. The upper contact portion 62 and the elongated lower portion 66 of the bumper 70 flex to release the striker wire 80 such that the fork bolt 30 may further rotate relative to the housing 20 to an open, unlatched position. In addition, because the force retaining the free end 78 of the flexible portion 74 in a bent position is withdrawn, the flexible portion 74 biases back to its original position. In conjunction with the rotation of the fork bolt 30, the movement of the curved flexible portion 74 about its first end 76 urges portion 82 of the striker wire 80 away from the bumper 60 and out of the opening 22 of the housing 20.

By incorporating the guide member 70 into the latch 10, portion 82 of the striker wire 80 is coerced into a wedged position between the upper contact portion 62 and the elongated lower portion 66 of the bumper 60. The guide member 70, improves the reliability of engagement between the striker 80 and the sound dampening bumper 60.

While the invention has been described with reference to an exemplary embodiment, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims.

What is claimed is:

1. A latch comprising:
a forkbolt configured to rotate between an unlatched position and a latched position;
a detent configured to cooperate with the forkbolt;
a bumper having an upper contact portion and an elongated lower portion, the bumper being configured to receive a striker when the fork bolt is in the latched position; and
a guide member including a generally curved flexible portion, the flexible portion being configured to deflect about a first end to guide the striker towards the upper contact portion of the bumper.

2. The latch according to claim 1, wherein the flexible portion of the guide member is formed from a plastic material.

3. The latch according to claim 1, wherein the bumper is formed from a flexible material.

4. The latch according to claim 1, wherein the guide member includes a generally rigid base.

5. The latch according to claim 4, wherein the flexible portion of the guide member deflects towards the base.

6. The latch according to claim 1, wherein the guide member extends from a housing of the latch.

7. The latch according to claim 6, wherein a portion of the guide member is formed integrally with the housing.

8. The latch according to claim 6, wherein the flexible portion of the guide member extends from adjacent a mouth of an opening in the housing to adjacent the upper contact portion of the bumper.

9. The latch according to claim 1, wherein the upper contact portion of the bumper includes an angled surface configured to wedge the striker between the upper contact portion and the lower portion.

10. The latch according to claim 9, wherein rotation of the forkbolt moves the striker along the curved flexible portion of the guide member.
